(19) United States
(12) Patent Application Publication
(10) Pub. No.: US 2004/0243976 A1
(43) Pub. Date: Dec. 2, 2004

(54) Assembly language tool kit and method

(76) Inventors: Miroslav Kostecki, South Australia (AU); Yun Peng Choo, South Australia (AU)

Correspondence Address: Klauber & Jackson, Continental Plaza, 411 Hackensack Avenue, Hackensack, NJ, 07601, US

(21) Appl. No.: 10/482,687

(22) PCT Filed: Jul. 3, 2002
(86) PCT No.: PCT/AU02/00871

(30) Foreign Application Priority Data
Jul. 3, 2001 (AU) PR6059

(51) Int. Cl. G06F 9/44

(52) U.S. Cl. 717/108

(57) ABSTRACT

A tool kit and method for increasing the efficiency of programming a microprocessor or microcontroller in assembly language. The method includes grouping a plurality of assembly language opcodes under a single symbol such that one of the plurality of opcodes can be defined upon selecting the symbol and defining one or more parameters related to that symbol.

### TECHNICAL FIELD

This invention relates to programming in assembly language for programming microcontrollers and microprocessors.

### BACKGROUND TO THE INVENTION

The earliest computers were programmed using binary codes, consisting of sequences of 1's and 0's. Binary codes are very difficult for human beings to work with directly as it is very difficult for humans to extract patterns from a sequence of digits of 1's and 0's.

To facilitate the programming and reading of binary code, machine code, or assembly language was developed. Assembly language consists of a number of instructions or opcodes which represent a particular instruction carried out by a sequence of binary code.

This resulted in a great increase in the efficiency and ease of use in programming microprocessors however, as the number of opcodes increased dramatically with the advent of more complex computer hardware, it became increasingly more difficult to use and remember the number of codes available. Another problem is that in entering opcodes (generally consisting of strings of data), errors can be made by the programmer resulting in either an incorrect opcode being entered or the assembler not recognising a particular opcode.

Attempts to alleviate these problems resulted in the development of higher level programming languages, which use more natural syntax to carry out functions. However, this results in a loss in speed in the central processing unit (CPU) executing the program and a reduction in flexibility when compared to using assembly language opcodes.

It is an object of the present invention to improve the efficiency and ease of programming in assembly language while reducing the delays incurred in using higher level programming languages.

### SUMMARY OF THE INVENTION

According to a first aspect of the present invention, there is provided a method for improving the efficiency of programming in assembly language, the method comprising grouping together under one symbol, two or more assembly language instructions such that selection of that one symbol, together with one or more predetermined parameters, defines one of the two or more assembly language instructions.

According to a second aspect of the present invention, there is provided a tool kit for creating a program in assembly language for a microprocessor, the tool kit comprising a user interface providing access to a plurality of symbols, at least one of which represents two or more assembly language instructions grouped under that symbol, such that selection of that symbol, together with one or more predetermined parameters, defines one of the two or more assembly language instructions grouped under that symbol.

According to a third aspect of the present invention, there is provided a method of creating a program in assembly language for a microprocessor, the method comprising selecting at least one of a plurality of symbols at least one of which represents two or more assembly language instructions such that selection of that at least one symbol together with one or more predetermined parameters, defines one of the two or more assembly language instructions and providing a value relating to each of the one or more predetermined parameters.

Preferably, the symbol will be a graphical symbol.

Preferably, the graphical symbol will include an element suggesting the function of the two or more assembly language instructions represented by the graphical symbol.

### BRIEF DESCRIPTION OF THE DRAWINGS

The invention will now be described in more detail with reference to the following figures in which:

FIG. 1—shows an opening screen of a programming tool according to the present invention;

FIG. 2—shows a screen used in configuring various parameters of a microcontroller being programmed;

FIG. 3—shows the ASSIGNMENT symbol with associated window;

FIG. 4—shows the CALCULATE symbol with associated window;

FIG. 5—shows the CALL symbol with associated window;

FIG. 6—shows the RETURN symbol with associated window;

FIG. 7—shows the GOTO symbol with associated window;

FIG. 8—shows the COUNT SKIP IF 0 symbol with associated window;

FIG. 9—shows the SET symbol with associated window;

FIG. 10—shows the SKIP IF symbol with associated window;

FIG. 11—shows the TIMING symbol with associated window;

FIG. 12a—shows a first screen of an exemplary program;

FIG. 12b—shows a second screen of the exemplary program;

FIG. 12c—shows a third screen of the exemplary program;

FIG. 12d—shows a first screen of subroutine “pip” of the exemplary program;

FIG. 12e—shows a first screen of subroutine “delay” of the exemplary program; and

FIG. 12f—shows a second screen of subroutine “delay” of the exemplary program.

### DETAILED DESCRIPTION OF THE PREFERRED EMBODIMENT

In accordance with the concept of the present invention, two or more “similar” opcodes are associated with a symbol (whether it be a text or graphic symbol). Upon selection of the symbol, the more specific operation of that symbol may be selected from any options available on that symbol. In this way, every opcode grouped under that symbol can be accessed and caused to perform its particular operation.

For example, in one particular microcontroller, some of the opcodes available are as follows:

CLRF f, CLRW, MOVF f,d, MOVWF f, MOVLW k

According to the invention, each of these opcodes is grouped under a single symbol which for the purposes of the example is called “CRYSTAL”.

If any of the above opcodes are needed, then the CRYSTAL symbol would be selected which then requires the entry of one or more parameters. For example, these parameters could be either “f” or “w”. A second parameter might then be chosen from the range of “0”, “f”, “w” or “k”. Thus, the same group of instructions referred to above would become:

CRYSTAL f=0, CRYSTAL w=0, CRYSTAL w=f, CRYSTAL f=w, CRYSTAL w=k.

The five separate opcodes referred to above have now become a single instruction (symbol) plus two options. While it is possible for the symbol to be a text element, it is preferably a graphic symbol having associated with it two drop down menus containing various options for the required parameters.

A specific implementation of the present invention will now be described in the form of a programming tool designed to program a microcontroller using the graphic symbol feature of the present invention.

Now described is a symbol-based programming tool designed to replicate all the instructions available in the Micro chip 16F84 instruction set. It utilises windows and drop down menus in which all the information contained in a text instruction can be entered and implemented on variables and literals.

While the programming symbols provide a convenient method of entering instructions and data, it is still preferable that the programmer have a knowledge of the register, memory and instruction set relative to the 16F84. The names assigned to the symbols are representative of the group of functions hidden behind each button.

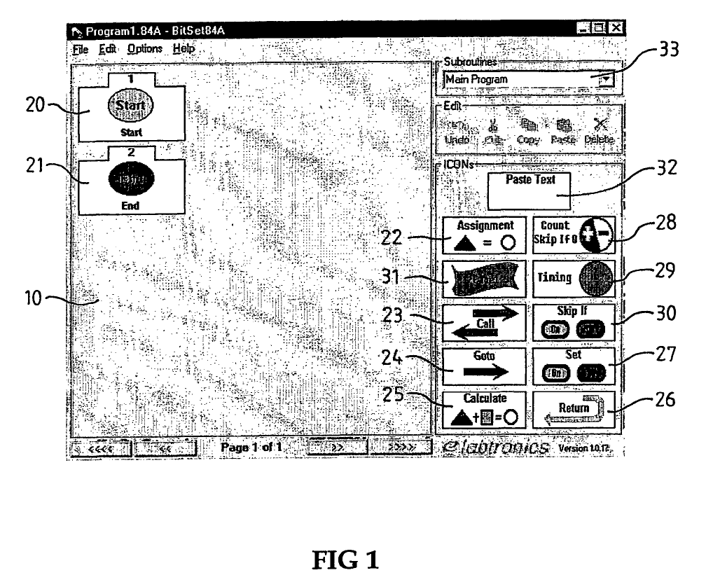

FIG. 1 shows an opening screen 10 of the programming tool. Upon opening the tool, screen 10 appears showing various symbols as will be described in more detail below. Instructions have been divided into 9 main groups represented by symbols situated on the programming interface. Every program will be contained within a Start symbol 20 and an End symbol 21. The various symbols 22 to 30, represent the nine main groups of the opcode instruction set of the 16F84 microprocessor. The function of each of these symbols is detailed in the table below.

### Summary of Symbol Operations

| | |
|---|---|
| Start | Initializes the program, port and control register settings. |
| End | Signals end of program to the assembler. |
| Assignment | Copies the value of one variable to another variable, |
| | deleting and creating new variables. |
| Calculate | Arithmetic operations, ie. add, subtract, logic, |
| | complement, rotate, increment, decrement and swap. |
| Call | Call subroutine (label). |
| Count Skip if 0 | Increment or decrement register (variable)-skip |
| | next instruction if the |
| | result is zero. |
| Goto | Go to label or specified address. |
| Return | Return from subroutine to next instruction, return with |
| | literal in w, return from interrupt. |
| Set/Reset | Set and clear specified register bits (variables). |
| Skip If | Test specified register bit (variable)-skip if set or clear. |
| Timing | Clear watch dog timer, no operation and enter |
| | standby mode (sleep). |

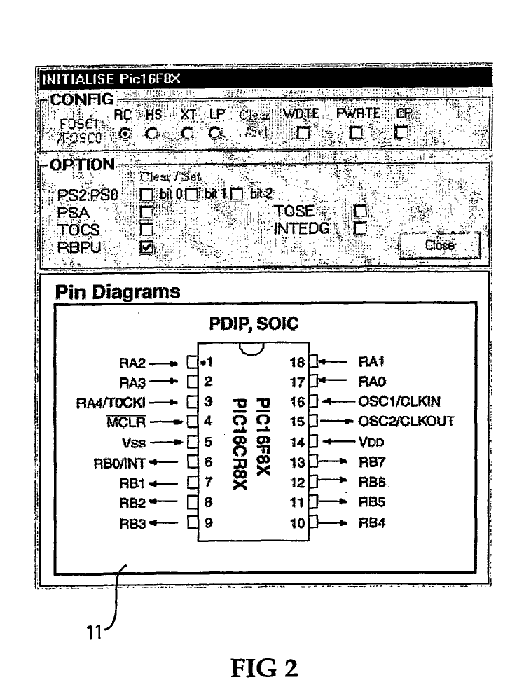

Before beginning the programming, it is necessary to configure the microcontroller being programmed. This is done by double clicking on Start symbol 20 which brings up the screen 11 shown in FIG. 2.

For introductory work, default settings can be accepted however, port settings may need to be changed. These may be changed by any convenient means for example by placing the cursor on an arrow and clicking, to change the direction of the arrow. The direction of the arrow signifies either an input or output for that port. The details relating to microprocessor configuration are not directly relevant to the present invention and will not be discussed in any further detail.

Each of the symbols 22 to 26 will now be described more fully.

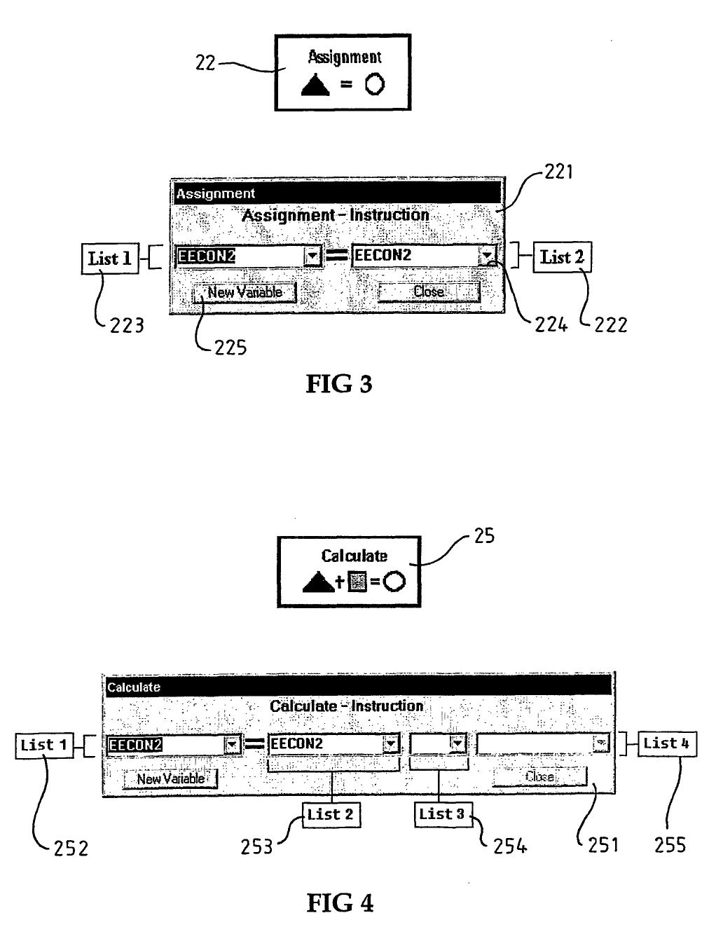

Beginning with the Assignment symbol 22 (see FIG. 3), the symbol 22 is shown together with a window 221 that is displayed to the user upon selection of symbol 22. The Assignment symbol copies the value of the variable in list 222 to the variable in list 221.

In list 1 any one of the default or user defined variables can be chosen. Default variables are those already in the list; user defined variables are created by the user.

If list 1 contains a variable other than register w, then the variable in list 2 must be 0, register w or the same as list 1.

If list 1 contains the register w, then list 2 can contain any of the variables from the pull down list (produced upon clicking on button 224), or any literal value (hex, dec, bin.).

A comparison of the Assignment symbol instructions with the microprocessor opcodes is shown below in table 1.

TABLE 1

| Bitset Instruction | | | | |
|---|---|---|---|---|
| List | | | PIC | |
| 1 | | 2 | Instruction | Comments/description |
| variable | = | 0 | clrf f | set variable to zero |
| w | = | 0 | clrw | set w to zero |
| w | = | variable | | set w to variable |
| | or | | movf f, d | |
| variable | = | variable | | set variable to variable |
| variable | = | w | movwf f | set variable to register w |
| w | = | k | movlw k | set w to literal number or |
| | | | | ASCII (e.g. “A”) |

f = variable,
d = destination (variable or register w),
k = literal number or ASCII

New variables can be added in several ways.

By accessing the options menu.

By adding and changing variables within combo boxes.

### Creating a New Variable

To create a new variable the New Variable button 225 is selected to display a variable list window (not shown). Variable names can be added or changes as desired.

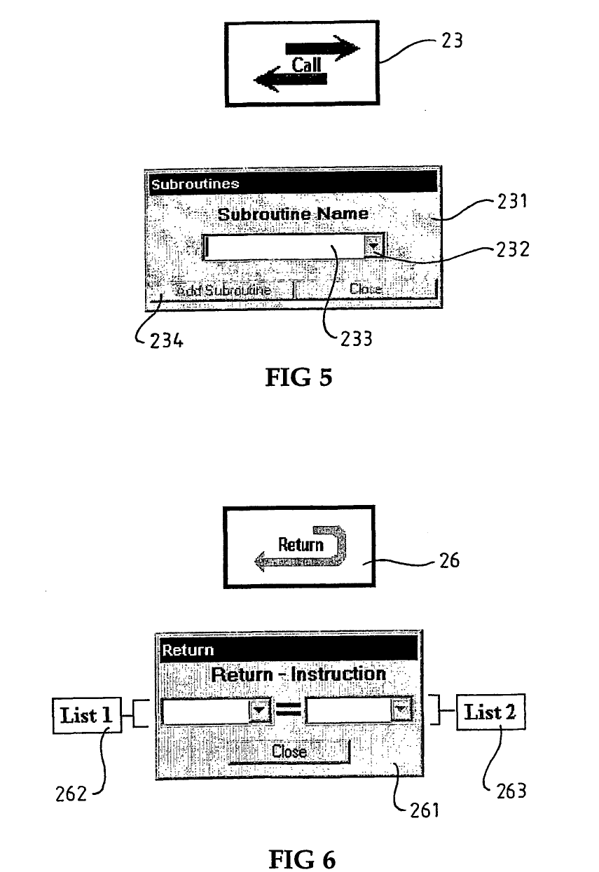

The Calculate symbol 25 (see FIG. 4), is inserted when one of a variety of arithmetic operations is to be executed. These are—add, substract, rotate, complement, increment, decrement, swap and logic operations.

Upon selecting the Calculate symbol 25, window 251 appears requiring entry of variables in each of four lists (252-255).

Depending on the operation, the List boxes must be entered accordingly.

List 1—is the destination of the operation. This will either be the w register or the variable (register) being operated on (either default or user defined).

List 2—the variable or literal value (operand) being used to operate on the w register

ie. as with add, subtract and logic operations.

With instructions in which the operation is only on a variable, then nothing is entered in the List 2 combo-box.

ie. complement, rotate and swap operations.

List 3—the operation to be carried out. The arrow symbols indicate the rotate direction.

When List 2 has been selected the following operations will be available in List 3.

OR, XOR, AND, + (increment), − (decrement).

If List 2 has been left blank then the only operations available are those involving bit manipulation on a given register.

ie. Flip, Swap, << (rotate left) and >> (rotate right).

List 4—indicates the variable upon which the operation is to be carried out. This may be user defined or the w register. In the case of increment and decrement instructions a 1 is entered.

The instructions chosen in (Lists 1, 2, & 3), will govern the options available in List 4.

If List 2 is selected

If Lists 1 & 2 contain default registers or user defined variables, then

List 4 can only contain register w or 1.

If List 1 contains the register w, and List 2 contains either the user defined or default variables, then List 4 can only contain register w or 1.

If List 2 is not selected

If List 1 contains the register w, then List 4 can contain any variable from the pull down list except register w or 1.

If List 1 contains a variable other than the variable w, then the List 4 must contain the same variable as List 1.

A comparison of the Calculate symbol instructions with the assembly language of the microprocessor opcodes is shown below in table 2.

TABLE 2

| Symbol Instructions | | | | | | |
|---|---|---|---|---|---|---|
| List Columns | | | | | PIC | |
| 1 | = | 2 | 3 | 4 | Instruction | Comments and description |

Arithmetic Operations

| | | | | | | |
|---|---|---|---|---|---|---|
| variable | = | Variable | + | W | addwf f, d | Add w and variable to variable |
| w | = | Variable | + | W | addwf f, d | Add w and variable to w |
| variable | = | Variable | − | W | subwf f, d | Subtract w from variable |
| w | = | Variable | − | W | subwf f, d | Subtract w from variable |
| w | = | K | + | W | addlw k | Add literal and w |
| w | = | K | − | W | sublw k | Subtract w from literal |
| variable | = | Variable | + | 1 | incf f, d | Add variable by 1 |
| w | = | Variable | + | 1 | incf f, d | Add variable by 1 |
| variable | = | Variable | − | 1 | decf f, d | Subtract variable by 1 |
| w | = | Variable | − | 1 | decf f, d | Subtract variable by 1 |

Logical Operations

| | | | | | | |
|---|---|---|---|---|---|---|
| variable | = | Variable | OR | W | iorwf f, d | Inclusive OR w with variable |
| w | = | Variable | OR | W | iorwf f, d | Inclusive OR w with variable |
| w | = | K | OR | W | iorlw k | Inclusive OR literal with w |
| variable | = | Variable | XOR | W | xorwf f, d | Exclusive OR w with variable |
| w | = | Variable | XOR | W | xorwf f, d | Exclusive OR w with variable |
| w | = | K | XOR | W | xorlw k | Exclusive OR literal with w |
| variable | = | Variable | AND | W | andwf f, d | AND w with f |
| w | = | Variable | AND | W | andwf f, d | AND w with f |
| w | = | K | AND | W | andlw k | AND literal with w |

Bit Manipulations

| | | | | | | |
|---|---|---|---|---|---|---|
| variable | = | (blank) | FLIP | Variable | comf f, d | Complement variable |
| w | = | ″ | FLIP | Variable | comf f, d | Complement variable |
| variable | = | ″ | >> | Variable | rrf f, d | Rotate right variable through carry |
| w | = | ″ | >> | Variable | rrf f, d | Rotate right variable through carry |
| variable | = | ″ | << | Variable | rlf f, d | Rotate left variable through carry |
| w | = | ″ | << | Variable | rlf f, d | Rotate left variable through carry |
| variable | = | ″ | SWAP | Variable | swapf f, d | Swap first 4 bits with last 4 bits |
| w | = | ″ | SWAP | Variable | swapf f, d | Swap first 4 bits with last 4 bits |

f = variable,
d = destination (variable or register w),
k = literal number or ASCII

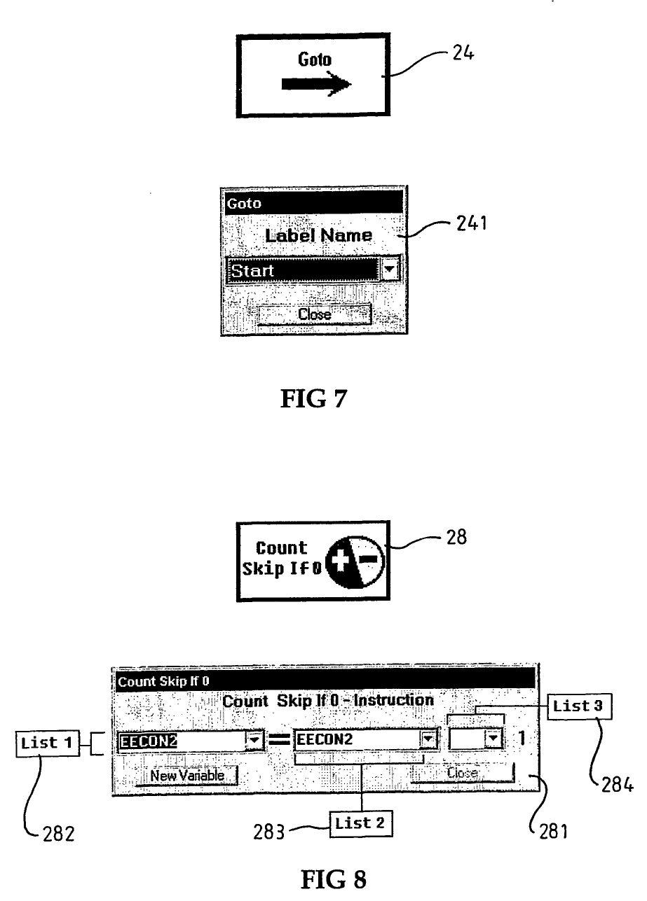

The Call symbol 23 is shown in FIG. 5 together with a subroutine window 231 which appears upon selection of call symbol 23.

The Call symbol 23 is used to tell the program to go to a specified Subroutine (not a Label). When a particular subroutine is invoked by using the Call symbol 23, a

Return will always be executed to return to the main program and continue with the execution of the next symbol after the Call symbol.

A specific subroutine may be selected by clicking on button 232 which will display a list on a pull down menu (not shown) of all subroutines available.

A new subroutine may be added by typing the name of the subroutine in the window 233 and clicking the “Add Subroutine” button 234.

A comparison of the Call Symbol Instruction with the microcontroller assembly instructions is shown below in table 3.

TABLE 3

| Symbol Instruction | | |
|---|---|---|
| List | PIC Instruction | Comments and description |
| (subroutine) | Call k | call subroutine by label (name) |

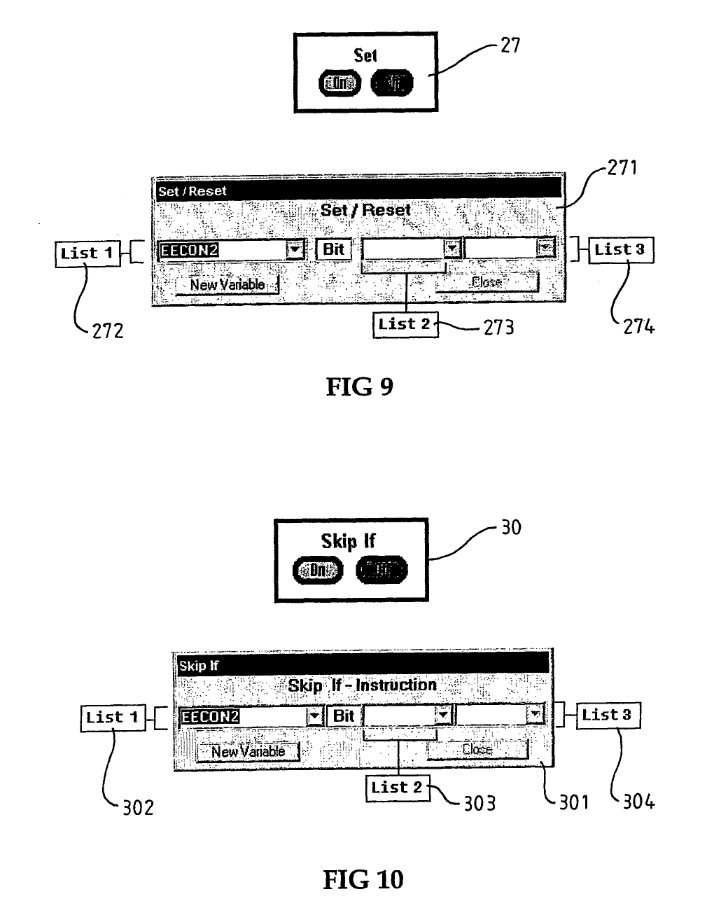

The Return symbol 26 is shown in FIG. 6 together with the window 261 that is displayed upon selection of Return symbol 26.

The Return symbol 26 tells the program to return to the main program from a subroutine.

The Return symbol can only be inserted in a subroutine page.

Option 1—If nothing is entered or selected from the pull down lists, the program by default will return to the execution of the main diagram.

Option 2—If List 1 (262) contains register w and List 2 (263) contains any literal value, when the return to the main program takes place the value in List 2 is copied into the w register.

Option 3—The interrupt option can be selected from the pull down list.

The Return symbol cannot be deleted if it is the only Return symbol in the Subroutine page.

The Return Symbol Instruction set is compared wit the microcontroller assembly instruction set in table 4 below.

TABLE 4

| Symbol Instruction | | | | |
|---|---|---|---|---|
| List Columns | | | | |
| 1 | | 2 | PIC Instruction | Comments and description |
| (blank) | = | (blank) | Return | return from subroutine |
| w | = | k | Retlw k | return with literal in w |
| interrupt | = | (blank) | Retfie | return from interrupt |

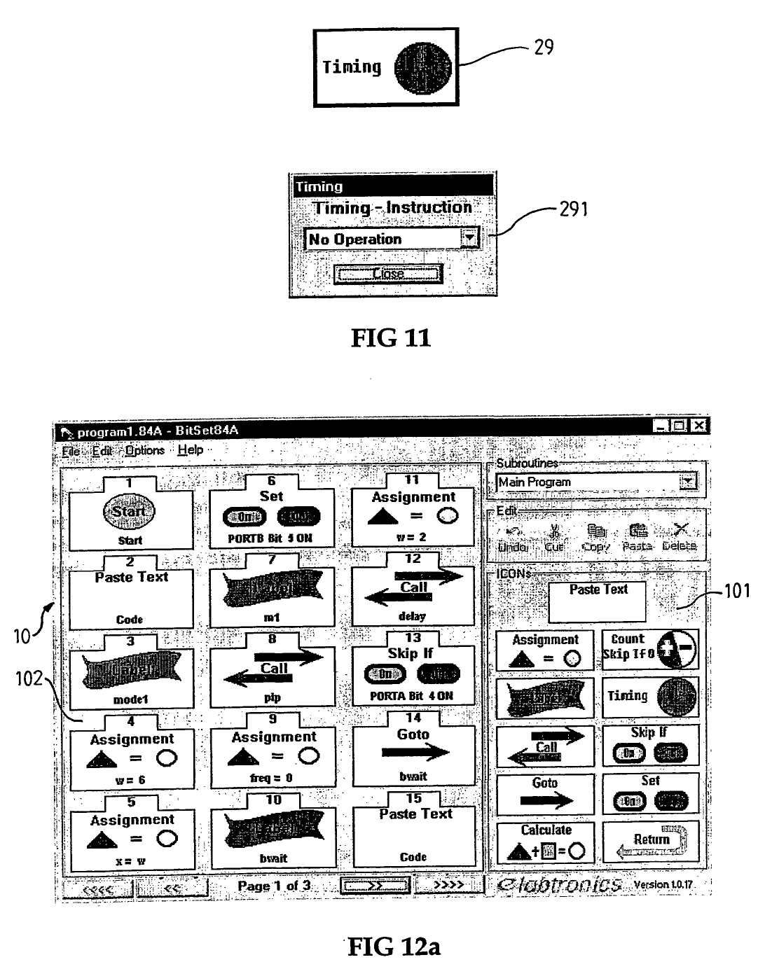

The Goto symbol 24 is shown in FIG. 7 together with window 241 which appears upon selection of symbol 24.

The Goto symbol is used to tell the program to go to a specified Label in the program. It is not used to go to a subroutine. The program counter jumps to the address of the specified Label and then continues to execute program instructions from that address onwards.

The required Label to which the program should go to may be selected from the pull down list (not shown).

When a Goto symbol is added to the main program, only Labels declared in the main program can be selected from the pull down list.

When a Goto symbol is added to a subroutine, only Labels declared in the subroutine can be selected from the pull down list.

Within a subroutine page a Goto symbol cannot be used if no Label is declared.

A comparison of the Goto Symbol Instruction set with the microcontroller assembly instruction set is set out in table 5 below.

TABLE 5

| Symbol Instruction | PIC | Comments |
|---|---|---|
| List Columns | Instruction | and description |
| (Label name) | Goto k | go to label |

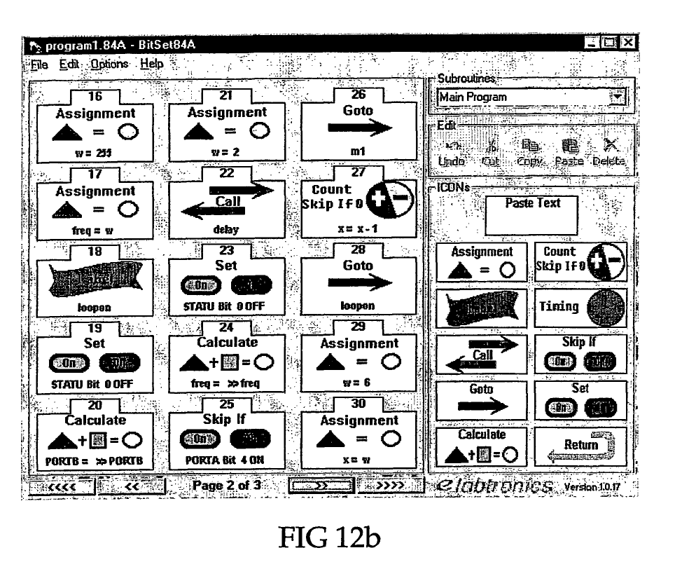

The Count Skip instruction 28 is shown in FIG. 8 together with its associated window 281 allowing variables to be entered as required.

The Count Skip symbol is used to make the program counter jump the next instruction (symbol) if the result of either a decrement or increment of a variable (register) results in zero. The operation is used as a testing tool (ie. when counting or creating time delays).

List 1 (282) is the destination of the operation and must be the variable being operated on or w the working register.

List 2 (283) is the variable being operated on. List 2 must be the same as (List 1) except if the destination is w ie. the working register.

List 3 (284) allows the choice of either the increment or decrement operations (+/−).

A new variable can be created within this window. However the Assignment process must be used to give a value to the variable.

A comparison of the Count Skip Symbol Instruction set with the microcontroller assembly instruction set is set out in table 6 below.

TABLE 6

| Symbol Instruction | | | | |
|---|---|---|---|---|
| List Columns | | | | |
| 1 | 2 | 3 | PIC Instruction | Comments and description |
| variable | variable | + | Incfsz f, d | increment variable, skip if zero |
| variable | variable | − | Decfsz f, d | decrement variable, skip if zero |

f = variable,
d = destination (variable or register w),
k = literal number or ASCII

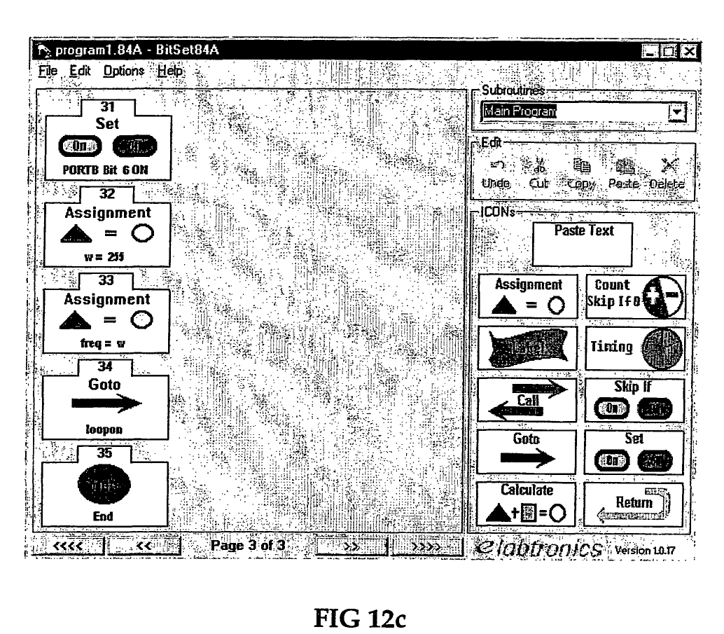

The Set/Reset symbol 27 is shown in FIG. 9 together with associated window 271 which is activated upon selection of symbol 27.

The Set/Reset symbol 27 is used to set (on) or to dear (off) a particular bit in either a default or user defined variable.

List 1 (272) drop down menu allows choice of the variable to be operated on. This may be either a default or user defined variable.

List 2 (273) allows the required bit in the variable to be chosen.

List 3 (274) allows the bit chosen to be set (1=on) or reset (0=off). List 2 must be chosen before List 3.

A new variable can be created within this window. However the Assignment process must be used to give a value to the variable.

A comparison of the Set/Reset Symbol Instruction set with the microcontroller assembly instruction set is set out in table 7 below.

TABLE 7

| Symbol Instruction | | | | |
|---|---|---|---|---|
| List Columns | | | | |
| 1 | 2 | 3 | PIC Instruction | Comments and description |
| variable | (Bit 0-7) | ON | bsf f, b | set variable bit |
| variable | (Bit 0-7) | OFF | bcf f, b | clear variable bit |

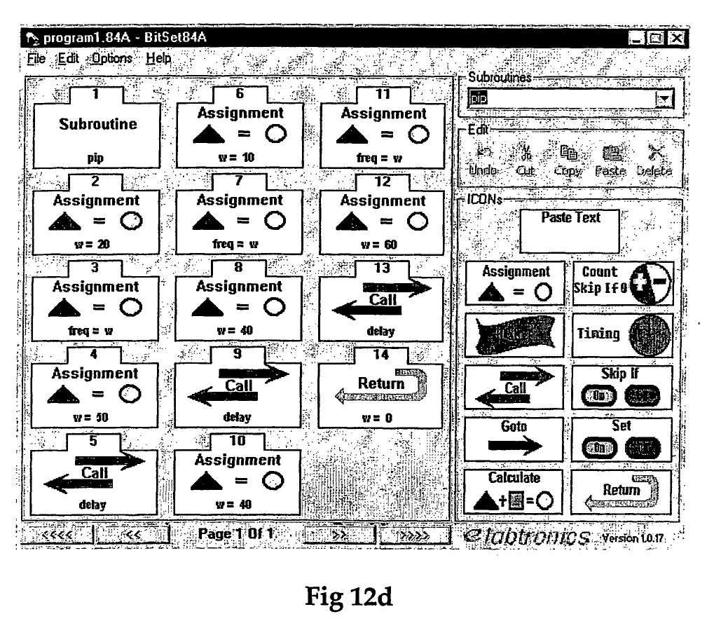

The Skip If symbol 30 is shown in FIG. 10 together with its associated window 301.

The Skip If symbol 30 is used to make the program counter jump the next instruction (symbol) when the result of a specified variable bit is dear or set. This operation is used as a testing tool. An example would be the testing of a switch to determine whether it is open or closed.

List 1 (302) provides the selection of default or user defined variables from which to choose.

List 2 (303) allows the required bit in the variable to be chosen.

List 3 (304) allows the bit chosen to be set (1=on) or reset (0=off). List 2 must be chosen before List 3.

A new variable can be created within this window. However the Assignment process must be used to give a value to the variable.

A comparison of the Skip If Symbol Instruction set with the microcontroller assembly instruction set is set out in table 8 below.

TABLE 8

| Symbol Instruction | | | | |
|---|---|---|---|---|
| List Columns | | | | |
| 1 | 2 | 3 | PIC Instruction | Comments and description |
| variable | (Bit 0-7) | ON | btfss f, b | bit test variable, skip if set |
| variable | (Bit 0-7) | OFF | btfsc f, b | bit test variable, |
| | | | | skip if clear |

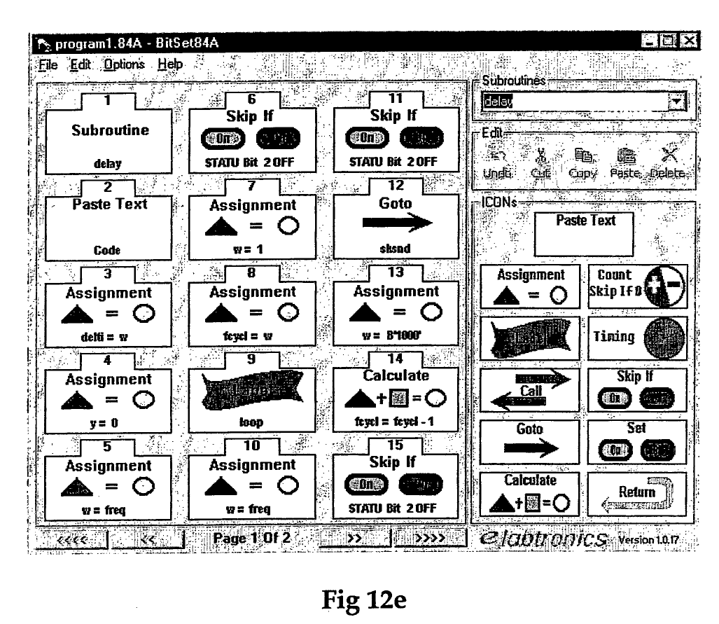

The Timing symbol 29 is shown in FIG. 11 together with its associated window 291. When the Timing symbol 29 is inserted a window is displayed with three options available:

No operation

Clear Watchdog timer

Sleep

No operation—no function is carried out except that the program counter advances by one cycle.

Clear Watchdog timer—clears the watchdog timer. This instruction is only used if the watchdog timer is set as part of the initialisation process.

Sleep—power downs the processor and stops program execution until an interrupt is received.

From an external reset input on the MCLR pin.

Interrupt from RB0/INT pin, RB port change.

A comparison of the Timing Symbol Instruction set with the microcontroller assembly instruction set is set out in table 9 below.

TABLE 9

| Symbol | PIC | Comments |
|---|---|---|
| Instruction | Instruction | and description |
| No operation | Nop | no operation |
| Clear watch dog | Clrwdt | clear the watchdog timer |
| Sleep | Sleep | go into standby mode |

While not one of the main instruction symbols, label symbol 31 (see FIG. 1) may be used to label subroutines.

The paste text window 32 (see FIG. 1), allows a source code previously created in a text editor to be inserted into the program. A source code can also be typed into the text provided. This can also be used for documentation of programs where comments and explanations can be inserted to help with the understanding of a program. When inserting comments, the comments should be preceded with a semi-colon (;) to avoid compilation errors.

Window 33 on FIG. 1 allows subroutines to be selected and edited. As subroutines are added to the main program, the name of each subroutine is added to a drop down menu which can be revealed upon clicking on the down arrow of window 33.

An example program will now be presented to illustrate the use of the present invention. The assembly language opcodes for a program to turn on at random, one of six LED's connected to a microprocessor, is shown in Appendix A. The program is written in the traditional manner using normal assembly language opcodes.

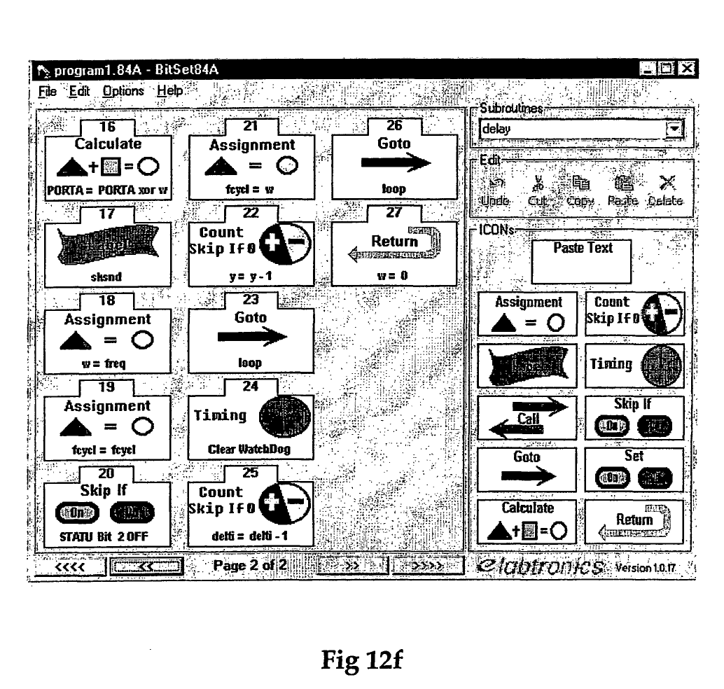

Using the tool kit of the present invention, the entire program (shown in Appendix A) can be constructed using the symbols shown and specifying their various parameters. FIGS. 12a to 12c show screens containing the main program. FIG. 12a shows page 1 of 3 showing symbols 1 to 15 which are selected from area 101 on screen 10, and selectively placed in area 102 simply by dragging the selected symbol.

FIG. 12b shows page 2 of 3, being symbols 16 to 30 and FIG. 12c shows page 3 of 3, being symbols 31 to 35. FIG. 12d shows page 1 of subroutine “pip” used within the main program, while FIGS. 12e and f show first and second pages of subroutine “delay” used within the main program.

Appendix B shows a more detailed version of the effect of the program shown in FIGS. 12a to f for illustrative purposes only.

Upon completion of the program, the program is compiled and may be downloaded onto a microcontroller by any suitable means.

As well as providing a far more efficient way of programming microcontrollers and microprocessors, due to its simplicity, the invention also allows children and students to experience programming microcontrollers and microprocessors. The invention allows graphical and intuitive programming which is far easier to learn than having to memorise many opcodes.

It will be appreciated that the above has been described with reference to a particular embodiment and that many variations and modifications may be made within the scope of the present invention.

For example, the above has been described in relation to a specific microcontroller (namely the 16F84 microcontroller), and accordingly the particular opcode instructions will be particular to that microprocessor. It will be understood that other microprocessors may use different opcode instructions and accordingly, the grouping of opcode instructions to symbols may be different to that disclosed herein to cater for the particular microprocessor being used. Furthermore, additional symbols to those described herein may be provided to cater for an expanded opcode instruction set.

APPENDIX A
LIST p=16C84,r=DEC ; Put assembler into PIC16C84 mode.

; r=DEC means decimal numbers are
; assumed if ‘B’ or ‘h’ not specified.

| include “p16f84.inc” | | |
|---|---|---|
| ;**************Declare Variables************************ | | |
| x | equ | 12 |
| freq | equ | 13 |
| y | equ | 14 |

| fcycle | | equ 15 |
|---|---|---|
| deltim | | equ 16 |
| ;**************Initialise interrupt subroutine********** | | |
| goto 5 | | |
| ORG 4 | | |
| goto interrupt | | |
| ORG 5 | | |
| ;**************Initialise Ports************************* | | |
| _idlocs H‘e84a’ | | |
| _CONFIG B‘11111111110011’ | | |
| MOVLW | B‘10001111’ | |
| OPTION | | |
| CLRF | PORTA | |
| MOVLW | B‘00010111’ | |
| TRIS | PORTA | |
| CLRF | PORTB | |
| MOVLW | B‘00000000’ | |
| TRIS | PORTB | |
| ;**************Start Of Main Program******************** | | |
| Start | | |
| ; Mode 1 :Random LED's | | |
| ;==================== | | |
| ;Random LEDs on button Press: | | |
| ;Light chases down 6 LEDs, slows and stops randomly. | | |
| mode1 | | |
| movlw | 6 | ;w = 6 |
| movwf | x | ;x = w |
| bsf | PORTB, 5 | ;PORTB Bit 5 ON |
| m1 | | |
| call | pip | |
| clrf freq | ;freq = 0 | |
| bwait | | |
| movlw | 2 | ;w = 2 |
| call | delay | |
| btfss | PORTA,4 | ;If PORTA Bit 4 ON Skip Next |
| goto | bwait | |
| ; Spin LEDs | | |
| movlw | 255 | ;w = 255 |
| movwf | freq | ;freq = w |
| loopon | | |
| bcf | STATUS,0 | ;STATUS Bit 0 OFF |
| rrf | PORTB,f | ;PORTB = >> PORTB |
| movlw | 2 | ;w = 2 |
| call | delay | |
| bcf | STATUS,0 | ;STATUS Bit 0 OFF |
| rrf | freq,f | ;freq = >> freq |
| btfss | PORTA,4 | ;If PORTA Bit 4 ON Skip Next |
| goto | m1 | |
| decfsz x,f | | ;x = x −1 , Skip Next If Zero |
| goto | loopon | |
| movlw | 6 | ;w = 6 |
| movwf | x | ;x = w |
| bsf | PORTB,6 | ;PORTB Bit 6 ON |
| movlw | 255 | ;w = 255 |
| movwf | freq | ;freq = w |
| goto | loopon | |
| goto | $ | ;Safety Caching Loop |
| ;**************Subroutines****************************** | | |
| pip | | |
| movlw | 20 | ;w = 20 |
| movwf | freq | ;freq = w |
| movlw | 50 | ;w = 50 |
| call | delay | |
| movlw | 10 | ;w = 10 |
| movwf | freq | ;freq = w |
| movlw | 40 | ;w = 40 |
| call | delay | |
| movlw | 40 | ;w = 40 |
| movwf | freq | ;freq = w |
| movlw | 60 | ;w = 60 |
| call | delay | |
| retlw | 0 | ;w = 0 |
| delay | | |
| ; DELAY SUBROUTINE | | |
| ; ---------------- | | |
| ; DELAY - delays by {0.5 seconds * (working register)} and | | |
| sounds buzzer | | |
| ; Delay loaded from W | | |
| movwf | deltim | ;deltim = w |
| clrf | y | ;y = 0 |
| movf | freq,w | ;w = freq |
| btfsc | STATUS,2 | ;If STATUS Bit 2 OFF Skip Next |
| movlw | 1 | ;w = 1 |
| movwf | fcycle | ;fcycle = w |
| loop | | |
| movf | freq,w | ;w = freq |
| btfsc | STATUS,2 | ;If STATUS Bit 2 OFF Skip Next |
| goto | sksnd | |
| movlw | B‘1000’ | ;w = B‘1000’ |
| decf | fcycle,f | ;fcycle = f cycle − 1 |
| btfsc | STATUS,2 | ;If STATUS Bit 2 OFF Skip Next |
| xorwf | PORTA,f | ;PORTA = PORTA xor w |
| sksnd | | |
| movf | freq,w | ;w = freq |
| movf | fcycle,f | ;fcycle = fcycle |
| btfsc | STATUS,2 | ;If STATUS Bit 2 OFF Skip Next |
| movwf | fcycle | ;fcycle = w |
| decfsz y,f | | ;y = y −1 , Skip Next If Zero |
| goto | loop | |
| clrwdt | | ;Clear WatchDog |
| decfsz deltim,f | | ;deltim = |
| | | deltim −1 , Skip Next |
| If Zero | | |
| goto | loop | |
| retlw | 0 | ;w = 0 |
| interrupt | | |

| | |
|---|---|
| retfie | ;Interrupt |
| End | |

APPENDIX B

| | | | | |
|---|---|---|---|---|
| Icon # 1 | Label | Start | | |
| Icon # 2 | Paste Text | Code | ; Mode 1 | :Random LED's |

;===================
;Random LEDs on button Press:
;Light chases down 6 LEDs, slows and stops randomly.

| Icon #3 | Label | model | | | | |
|---|---|---|---|---|---|---|
| Icon #4 | Assignment | w | = | | 6 | |
| Icon #5 | Assignment | x | = | | w | |
| Icon #6 | Set | PORTB | 5 | | ON | |
| Icon #7 | Label | m1 | | | | |
| Icon #8 | Call | pip | | | | |
| Icon #9 | Assignment | freq | = | | 0 | |
| Icon #10 | Label | bwait | | | | |
| Icon #11 | Assignment | w | = | | 2 | |
| Icon #12 | Call | delay | | | | |
| Icon #13 | Skip If | PORTA | 4 | | ON | |
| Icon #14 | Goto | bwait | | | | |
| Icon #15 | Paste Text | Code | ; Spin LEDs | | | |
| Icon #16 | Assignment | w | = | | 255 | |
| Icon #17 | Assignment | freq | = | | w | |
| Icon #18 | Label | loopon | | | | |
| Icon #19 | Set | STATUS | 0 | | OFF | |
| Icon #20 | Calculate | PORTB = | | >> | | PORTB |
| Icon #21 | Assignment | w | = | | 2 | |
| Icon #22 | Call | delay | | | | |
| Icon #23 | Set | STATUS | 0 | | OFF | |
| Icon #24 | Calculate | freq = | | >> | | freq |
| Icon #25 | Skip If | PORTA | 4 | | ON | |
| Icon #26 | Goto | m1 | | | | |
| Icon #27 | CountSkipIf0 | x = | x | | −1 | |
| Icon #28 | Goto | loopon | | | | |
| Icon #29 | Assignment | w | = | | 6 | |
| Icon #30 | Assignment | x | = | | w | |
| Icon #31 | Set | PORTB | 6 | | ON | |
| Icon #32 | Assignment | w | = | | 255 | |
| Icon #33 | Assignment | freq | = | | w | |
| Icon #34 | Goto | loopon | | | | |
| Icon #35 | End | End | | | | |

Subroutines : pip

| | | | | |
|---|---|---|---|---|
| Icon #1 | subroutine | pip | | |
| Icon #2 | Assignment | w | = | 20 |
| Icon #3 | Assignment | freg | = | w |
| Icon #4 | Assignment | w | = | 50 |
| Icon #5 | Call | delay | | |
| Icon #6 | Assignment | w | = | 10 |
| Icon #7 | Assignment | freq | = | w |
| Icon #8 | Assignment | w | = | 40 |
| Icon #9 | Call | delay | | |
| Icon #10 | Assignment | w | = | 40 |
| Icon #11 | Assignment | freq | = | w |
| Icon #12 | Assignment | w | = | 60 |
| Icon #13 | Call | delay | | |
| Icon #14 | Return | w | = | 0 |

Subroutines : delay

| | | | |
|---|---|---|---|
| Icon #1 | subroutine | delay | |
| Icon #2 | Paste Text | Code | ; DELAY SUBROUTINE |

```
  ; --------------------
  ; DELAY - delays by {0.5 seconds * (working register) } and sounds
  buzzer
  ; Delay loaded from W
```

| | | | | | |
|---|---|---|---|---|---|
| Icon #3 | Assignment | deltim | = | | w |
| Icon #4 | Assignment | y | = | | 0 |
| Icon #5 | Assignment | w | = | | #66 |
| Icon #6 | Skip If | STATUS | 2 | | OFF |
| Icon #7 | Assignment | w | = | | 1 |
| Icon #8 | Assignment | fcycle | = | | w |
| Icon #9 | Label | loop | | | |
| Icon #10 | Assignment | w | = | | #66 |
| Icon #11 | Skip If | STATUS | 2 | | OFF |
| Icon #12 | Goto | sksnd | | | |
| Icon #13 | Assignment | w | = | | B′1000′ |
| Icon #14 | Calculate | fcycle = | fcycle − | | 1 |
| Icon #15 | Skip If | STATUS | 2 | OFF | |

| | | | | |
|---|---|---|---|---|
| Icon #16 | Calculate | PORTA = | PORTA xor | w |
| Icon #17 | Label | sksnd | | |

| Icon #18 | Assignment | w | = | #66 |
|---|---|---|---|---|
| Icon #19 | Assignment | fcycle | = | #64 |
| Icon #20 | Skip If | STATUS | 2 | OFF |
| Icon #21 | Assignment | fcycle | = | w |
| Icon #22 | CountSkipIf0 | y = | y | −l |
| Icon #23 | Goto | loop | | |
| Icon #24 | Timing | Clear WatchDog | | |
| Icon #25 | CountSkipIf0 | deltim = | deltim | −1 |
| Icon #26 | Goto | loop | | |
| Icon #27 | Return | w | = | 0 |

Subroutines : interrupt

| | | | |
|---|---|---|---|
| Icon #1 | subroutine | interrupt | |
| Icon #2 | Return | interrupt | = |

1. A method for improving the efficiency of programming in assembly language, the method comprising grouping together under one symbol, two or more assembly language instructions such that selection of that one symbol, together with one or more predetermined parameters, defines one of the two or more assembly language instructions.

2. A method according to claim 1, wherein the symbol is a graphical icon.

3. A method according to claim 2, wherein the symbol includes an element indicating the function of the two or more assembly language instructions.

4. A tool kit for creating a program in assembly language for a microprocessor, the tool kit comprising a user interface providing access to a plurality of symbols, at least one of which represents two or more assembly language instructions grouped under that symbol, such that selection of that symbol, together with one or more predetermined parameters, defines one of the two or more assembly language instructions grouped under that symbol.

5. A tool kit according to claim 4 wherein upon selection of said at least one symbol, a user is prompted to enter values relating to the one or more parameters.

6. A tool kit according to claim 4, wherein the symbol is a graphical icon.

7. A tool kit according to claim 6, wherein the symbol includes an element indicating the function of the two or more assembly language instructions.

8. A tool kit according to claim 4, wherein a plurality of symbols may be selected together with respective predetermined parameters, to provide a program for programming a microprocessor.

9. A method of creating a program in assembly language for a microprocessor, the method comprising;
selecting at least one of a plurality of symbols at least one of which represents two or more assembly language instructions such that selection of that at least one symbol together with one or more predetermined parameters, defines one of the two or more assembly language instructions; and
providing a value relating to each of the one or more predetermined parameters.

10. A method according to claim 9, wherein said at least one of said plurality of symbols is a graphical icon.

11. A method according to claim 10, wherein said at least one symbol includes an element indicating the function of the two or more assembly language instructions.

12. A method according to claim 9 further comprising selecting a plurality of said symbols, together with respective predetermined parameters to provide a program for programming a microprocessor.
